(19) United States
(12) Patent Application Publication
(10) Pub. No.: US 2012/0253713 A1
(43) Pub. Date: Oct. 4, 2012

(54) ESTIMATING THE CAPACITY OF A LI-ION BATTERY BASED ON INITIAL PART OF THE DISCHARGE CURVE

(75) Inventor: Martin Krajci, Palatine, IL (US)

(73) Assignee: CONTINENTAL AUTOMOTIVE SYSTEMS, INC., Deer Park, IL (US)

(21) Appl. No.: 13/027,895

(22) Filed: Apr. 1, 2011

(51) Int. Cl. G06F 19/00

(52) U.S. Cl. 702/63

(57) ABSTRACT

A system and method for testing a battery is provided. A load is connected in electrical series connection with the battery. A sensor may be in communication with the battery for measuring a battery discharge curve. A processor monitors an output of the battery and determines a battery status based on a slope of an initial portion of the battery discharge curve.

### BACKGROUND

1. Field of the Invention

The present invention generally relates to a system for testing a battery.

2. Description of Related Art

It has been observed that lithium ion (Lilon) batteries deteriorate relatively quickly and unpredictably compared to the lifetime of a vehicle. Therefore, if a battery is used in an automotive environment, especially as a back-up battery where it normally is never discharged, it is difficult to predict if the battery still has sufficient holding charge capacity or it has deteriorated so that it cannot provide its back-up function anymore and needs to be replaced.

In view of the above, it is apparent that there exists a need for an improved system for testing a battery.

### SUMMARY

In satisfying the above need, as well as overcoming the enumerated drawbacks and other limitations of the related art, the present disclosure provides a system and method for testing a battery. The system may include a sensor, a load, and a processor. The load may be connected in electrical series connection with the battery and the sensor may be in communication with the battery for measuring a battery discharge curve. The processor monitors an output of the sensor and determines a battery status based on a slope of the initial portion of the battery discharge curve.

Two possible methods of measuring Lilon battery capacity are the full discharge test and the quick test.

Full discharge test includes discharging the battery completely and calculating the capacity by measuring the load current and time duration of the discharge. The full discharge test is a very thorough test.

The problem with a full discharge test is its duration. It may take 1 hour for a 1 C discharge, followed by a 2 or more hour charge period. Any attempt to use the battery during this period may result in the test data being invalid and the test would have to be repeated. Also, if the battery is used as a critical back-up battery, for much of the test there may not be sufficient charge to provide the critical back-up function. Additionally, the thermal energy associated with the discharge may cause undesirable increase in the temperature of the circuitry, and the recharge of the energy would use vehicle power (alternator or vehicle battery) which is also undesirable.

A quick test may include a DC load test, AC impedance test, and other more complex improvements of the test.

Simple quick tests are unreliable, and more complex tests are usually extremely complex and proprietary, with varying degree of reliability.

In one example, three batteries of the same brand, stated capacity, and manufacturing batch, were fully charged to 4.1V and then discharged with a 2 A DC load. The first battery was new and had a measured capacity of 1295 mAh. The second and third batteries had deteriorated to various degrees due to prolonged exposure to high temperature and humidity. The first battery offered a marginal capacity of 634 mAh, and the second battery had deteriorated to 58 mAh. It has been estimated that 500 mAh is an acceptable capacity for a network access device backup application, which would make the marginal second battery still acceptable, but the third battery with a poor cell should be flagged for replacement. However, the voltage of the first, second, and third battery were not readily distinguishable. However, the initial slope of the discharge curve for each battery is significantly different and may be used to classify the status of each battery. As such, the measuring of an initial portion of the discharge curve and making a determination of the battery status based on the slope provides improved reliability over quick test scenarios, yet provides improved functionality over full discharge testing for in system testing.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for testing a battery;

FIG. 2 is a schematic view of a system with a telematics controller and network access device implemented within a motor vehicle;

FIG. 3 is a schematic view of a system including a telematics controller and a network access device;

FIG. 4 is a flowchart of a method for testing a battery;

FIG. 5 is a graph illustrating discharge curves of three sample batteries; and

FIG. 6 is a graph illustrating the first portion of a discharge curve of the three batteries in FIG. 5.

### DETAILED DESCRIPTION

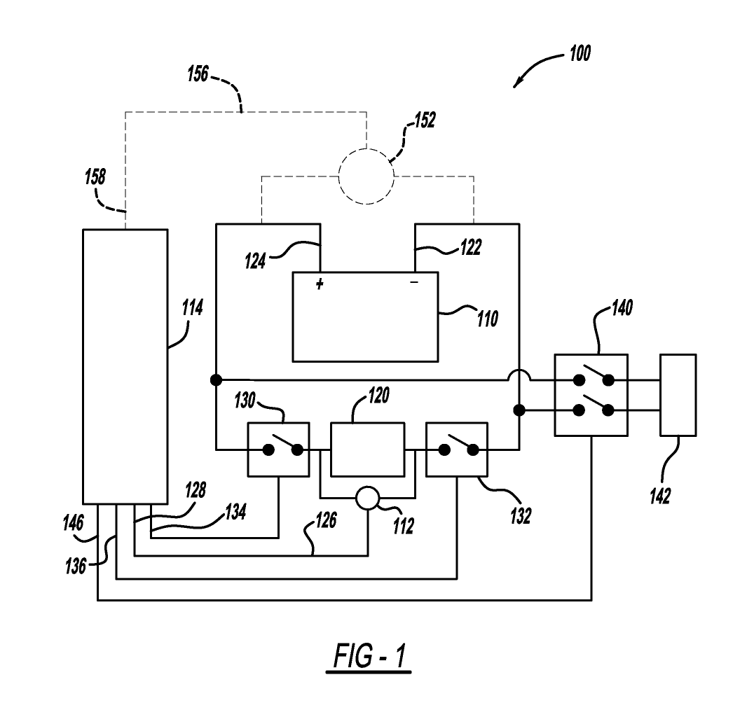

Now referring to FIG. 1, a system 100 for testing a battery is provided. The system 100 includes a sensor 112, a processor 114, and a load 120. The battery 110 has a positive connection 124 and a negative connection 122. The load 120 may be connected in series between the positive connection 124 and negative connection 122. A sensor 112 may measure the output of the battery 110.

In one scenario, the sensor 112 may be a voltage sensor connected in parallel with the load 120 to measure a voltage curve of the battery 110 as it discharges. Although other measurement methods may be used, for example, a current sensor could be placed in series with the load 120 to measure the current profile of the battery 110 as it discharges. Further, other sensors may be used to measure the voltage, current, or power through an inductive or capacitive sensor. As the sensor 112 measures the output of the battery, an output signal 126 is provided to an input 128 of the processor 114. In another optional aspect, the sensor may be configured as illustrated by sensor 152, output signal 156, and input 158.

In one example, the sensor 112 measures voltage and the signal 126 is a voltage signal that is provided to input 128 such as an analog to digital voltage input to provide a digital measurement of the voltage to the processor 114. The processor 114 may continuously store the voltage measurement to provide a voltage curve as the battery discharges through the load 120. Accordingly, as described above, other measurement methods may be used such that the processor 114 captures a series of measurements to form a battery discharge curve and analyze the battery discharge curve to determine a battery status. The processor 114 may analyze the battery discharge curve and, in particular, may measure an initial portion of the battery discharge curve. For example, the initial portion of the battery discharge curve may include the first one minutes to the first five minutes of the battery discharge curve.

The battery discharge curve may be analyzed by determining the average slope of the battery discharge curve, the maximum slope of the battery discharge curve, the maximum acceleration of the battery discharge curve, or the average acceleration of the battery discharge curve. Further, the slope of the battery discharge curve may be determined by taking the first derivative of the curve for example, using a difference algorithm. Further, the acceleration may be determined by taking the second derivative of the curve, which in one example may be obtained by performing a difference algorithm on the slope curve.

The processor 114 may include outputs 134 and 136 connected to one or more switches 130, 132 to disconnect the load 120 and/or the sensor 122 from the battery 110 during normal operation, when the battery is not being tested. In addition, the battery 110 may be connected to the vehicle battery 142 for charging purposes. As such, the system 100 may include a switch 140 to disconnect the battery 110 from the vehicle battery 142 for example, when the battery 110 is being tested or in instances where it may not be appropriate to charge battery 110 using vehicle battery 142.

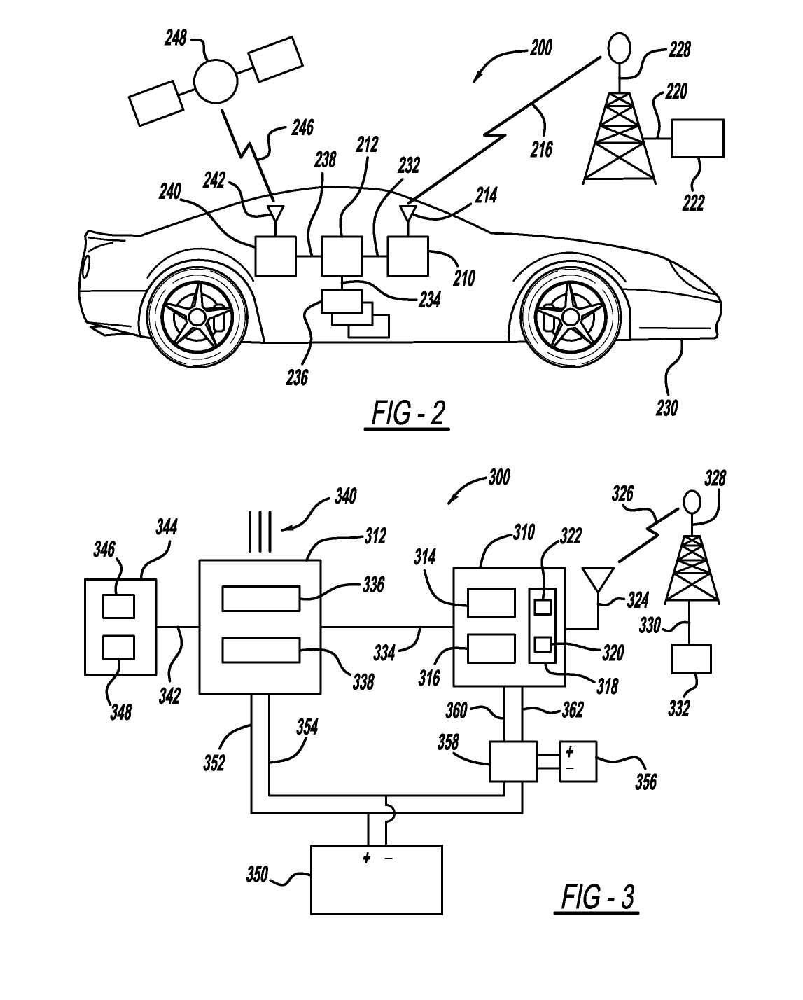

Now referring to FIG. 2, one possible implementation of the system 100 is provided within a vehicle 230. The network access device 210 may be provided in a separate package from the telematics controller 212. The network access device 210 may be connected to an antenna 214. The antenna 214 may be representative of a plurality of antennas or a matrix of antennas depending upon the particular communication mode selected. Communication of the network access device 210 is facilitated with a remote station 218 as denoted by line 216. As described previously, the remote station 218 may be in communication with a service provider 222 including a network server through a network 220. The telematics controller 212 may be in communication with a global positioning device 240 over the vehicle bus or a custom connection as denoted by line 238. The global positioning device 240, such as a satellite global positioning system (GPS), may be in communication with an antenna 242. The antenna 242 may be one of a plurality of antennas or a matrix of antennas. Further, the antenna or plurality of antennas represented by reference number 242 may be the same antennas as denoted by reference number 214. The GPS unit may be in communication with a satellite 248 as denoted by line 246. As such, the GPS unit 240 may retrieve positional data for the vehicle or in other implementations 240 may also represent a general satellite receiver and, therefore, may receive other general broadcast information or communication from the satellite 248. The telematics controller 212 may also be in communication with various other vehicle devices and systems through the vehicle bus, wire harnesses, or other wireless connections as denoted by line 234. The various other devices 236 may include but are not limited to the engine control system, the vehicle locks, the vehicle safety systems (e.g. seatbelt retractors, airbags, etc.), vehicle entertainment system, or a suspension control system.

Now referring to FIG. 3, a system 300 is provided. The system includes a network access device 310 and a telematics controller 312. The network access device 310 may include a processor 314 and storage 316. The processor 314 may be a programmable microprocessor or alternatively may be an application specific integrated circuit (ASIC), or other known processor. The storage 316 may be a memory, for example, random access memory, static memory, or other data storage device. The network access device 310 may also include a transceiver 318 which includes a transmitter 322 and a receiver 320. Alternatively, the network access device 310 may include an independent transmitter and receiver. The transceiver 318 may be in communication with an antenna 324. The transceiver 318 may communicate with a radio tower 328 as denoted by line 326. The communication 326 between the network access device 310 and the radio tower 328 may comprise one of a plurality of communication modes.

The transceiver 318 in the network access device 310 may be used for transmitting uplink communications and receiving downlink communication to and from the network 330 and service center 332 over the wireless communication link 326. The wireless communication link 326 may use a wireless protocol such as a standard cellular network protocol such as Advanced Mobile Phone Service (AMPS), Global System for Mobile Communications (GSM), Time Division Multiple Access (TDMA), Code Division Multiple Access (CDMA), and the like. To transmit data in the cellular environment, different types of standard bearer services exist including, but not limited to, general packet radio service (GPRS), short message service (SMS), circuit switched data service (CSD), and high-speed circuit switched data service (HSCSD). Further, standard transmission control protocol/internet protocol (TCP/IP) may also be used as well as satellite communications. In a further example, the transceiver 318 may be enabled using other wireless technologies such as Bluetooth technology. Bluetooth technology allows for the replacement of a wired connection by enabling devices to communicate with each other through a universal short-range radio link.

The radio tower 328 may be in communication with a service provider 332 including for example, a network server through a network 330. Network 330 may be an analog network such as a POTS or a digital network for example, Ethernet over TCPIP protocol. In other examples, the network 330 could be one of several standard cellular communication networks, a satellite-based network, a public switched telecommunication network (PSTN), the Internet, an integrated services digital network (ISDN), and/or other communication networks. The service provider may include a service center to provide telematics applications and services to the vehicle. For instance, the service center may contain operators, content servers and content databases. The content servers for telematics applications and services may include traffic servers, map servers, user profile servers, location information servers, and the like. The content databases for telematics applications and services may include location information, user profiles, traffic content, map content, point-of-interest content, usage history, and the like.

The network access device 310 may be in communication with the telematics controller 312 through a communication interface 334. In some implementations the network access device 310 may be in the same package as the telematics controller 312. However, other implementations the network access device 310 may be provided in a separate package from the package of the telematics controller 312 and, therefore, may be located in a different area of the vehicle. Various information may be communicated between the telematics controller 312 and the network access device 310.

The network access device 312 may include a processor 336 and storage 338. The processor 336 may be a microprocessor, an application specific integrated circuit, a programmable gate array, or other processor. Further, the storage 338 may be a memory device for example, random access memory, read only memory, static memory, or may even be a hard drive or optical drive, or other means of data storage. The telematics control 312 may be in communication with a plurality of other vehicle sensors and devices through a wire harness or over the vehicle bus as denoted by lines 340. In addition, the telematics controller 312 may be in communication with a user interface 344 as denoted by line 342. The user interface 344 may include a display 346 and controls 348 for providing user input such as vehicle parameters into the telematics controller 312. Also, the user interface 344 may include elements such as a keyboard or keypad, one or more control buttons, indicator lights, one or more speakers, a microphone, and any other user interface type elements for telematics applications and services. Optionally, the telematics controller 312 may also be connected to a positioning unit. The positioning unit could be a system that determines the geographic location of the vehicle such as a global positioning system (GPS), a dead-reckoning system, and the like.

Further, the telematics controller 312 may be in communication with other vehicle systems, such as the engine control system, the vehicle lock controls, the vehicle safety systems (e.g. seatbelt retractors, airbags, etc.), vehicle entertainment system, or a suspension control system to implement the described functions of the telematics controller 312 or network access device 310 based on parameters of such systems.

The telematics controller 312 may be powered by the vehicle battery 350 as denoted by lines 352 and 354. Alternatively, a voltage converter may be provided to convert from the vehicle battery voltage to a different voltage that may be appropriate for running the telematics controller 312. The voltage converter may be included in the package for the telematics controller 312 or alternatively may be in a separate package between the vehicle battery 350 and the telematics controller 312. The vehicle battery 350 may also provide power to the network access device 310.

A circuit 358 may be included between the vehicle battery 350 and the network access device 310. The circuit 358 may include a voltage converter to change the voltage provider to the network access device 310 in lines 360 and 362. In addition, the circuit 358 may be connected to a network access device battery 356. The network access device battery 356 may be charged while the vehicle is running and may for example, be switched to provide power to the network access device 310 when power from the vehicle power system (e.g., the battery or alternator) is not available. Further, the circuit 358 may control the monitoring and periodic powering of the network access device if the vehicle is turned off for a long period of time. Further, the circuit 358 may control the charging of the network access device battery 356 at appropriate times according to the environmental variables or the expected use cycle of the vehicle.

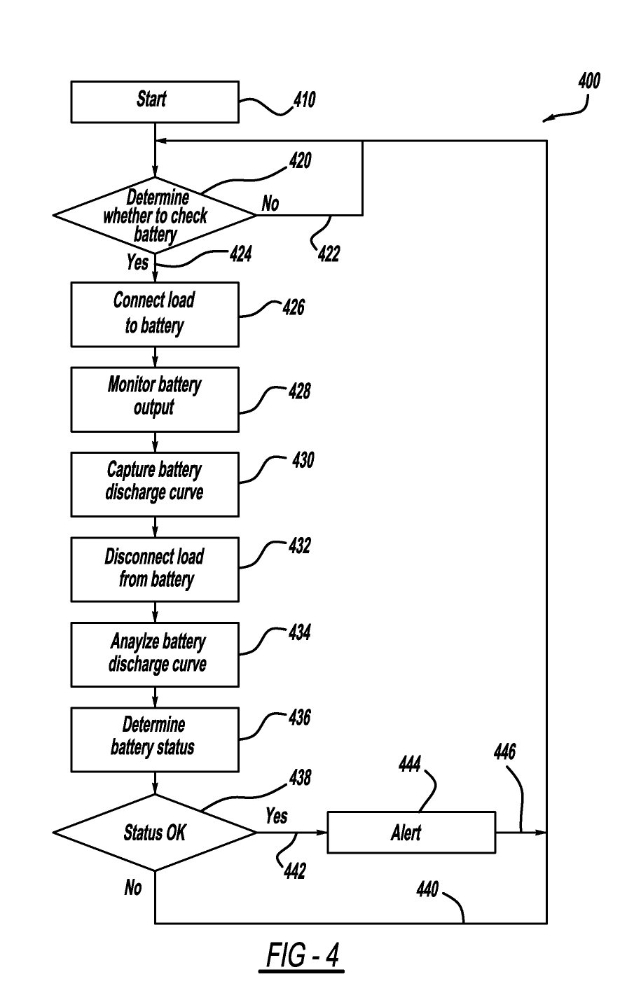

Now referring to FIG. 4, a method is provided for testing the battery. The method starts in block 410. In block 420, the system checks if the criteria is met for testing battery. In one example, the criteria may dictate that the battery is checked periodically according to a certain time period. The battery output may also be tested to check if the battery is fully charged before testing. If it is determined not to check the battery, then the method follows line 422 to block 420, where the battery may be checked until it is appropriate to test the battery. If it is determined to check the battery in block 420, the method follows line 424 to block 426. In block 426, the load is connected to the battery. In block 428, the battery output is monitored. In another aspect, the battery output is measured by a sensor over a time period. As discussed above, the output of the battery that is monitored may include one or more of the battery voltage, the current, or power output. In block 430, the battery output is captured over the time period to generate a battery discharge curve. Again as discussed above, the discharge curve may be a voltage curve, a current curve, or a power curve. In block 432, the load is disconnected from the battery after the battery discharge curve has been captured. Disconnecting the load from a battery may also include disconnecting the sensor from the battery as well. The load may be disconnected from the battery by activating one or more switches to isolate the battery from the load.

In block 434, a processor may analyze the battery discharge curve. The battery discharge curve may be analyzed by determining the average slope of the battery discharge curve, the maximum slope of the battery discharge curve, the maximum acceleration of the battery discharge curve, or the average acceleration of the battery discharge curve. Further, the slope of the battery discharge curve may be determined by taking the first derivative of the curve, for example, using a difference algorithm. Further, the acceleration may be determined by taking the second derivative of the curve, which in one example may be obtained by performing a difference algorithm on the slope curve. In block 436, the processor may determine the battery status. The battery status may be identified by determining if the slope of the battery discharge curve and/or the acceleration of the battery discharge curve exceed respective slope and acceleration thresholds. Alternatively, a weighted formula may be used to combine various slope and acceleration parameters to determine a battery status number that may be compared with one or more thresholds corresponding to a battery status. The formula may include various weighting and may also include various scaling factors for the type of battery, the size of the load, and various environmental conditions including, for example, ambient temperature.

If it is determined that the battery status is acceptable in block 438, the method proceeds along line 440 to block 420, where the method loops until it is once again determined to check the battery. If it is determined that the battery is not acceptable in block 438, the method follows line 442 to block 444, where an alert is generated for the battery. The alert may be then provided to a vehicle display, for example, through the telematics system. Alternatively, the alert may be provide to a network access device and transmitted to a service provider to schedule appropriate maintenance or contact the driver. The method then follows line 446 to block 420 where the method continues.

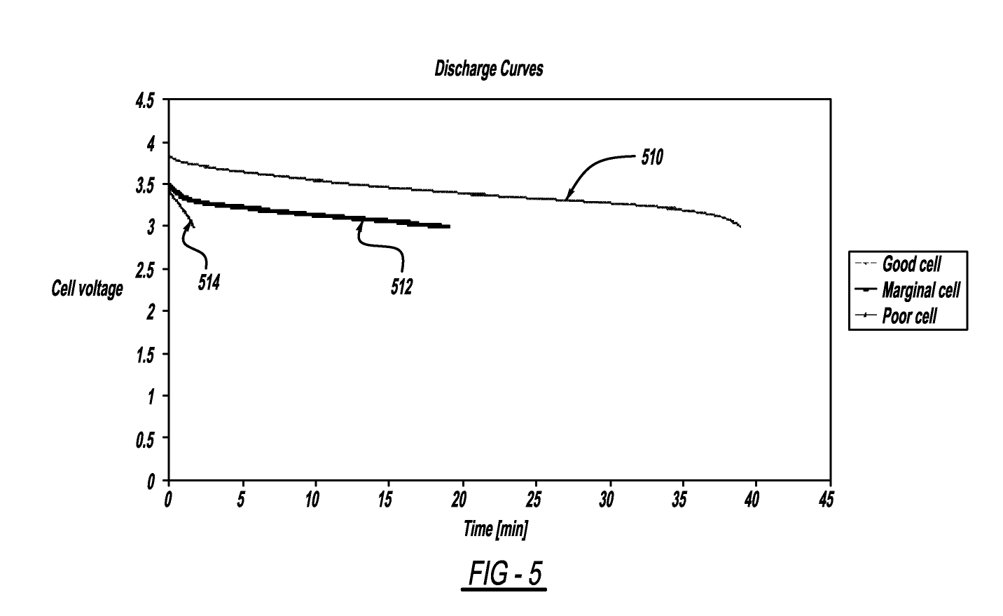

Now referring to FIG. 5, a discharge curve of three sample batteries is provided. The first battery is considered a good cell and is illustrated by line 510. The second battery is a marginal cell and is illustrated by line 512. The third battery is a poor cell and is illustrated by line 514. The first, second, and third batteries are of the same brand, stated capacity, and manufacturing batch. The batteries are fully charged to 4.1V and then discharged with a 2 A DC load. The first battery was new and measured capacity was 1295 mAh. The second and third batteries have deteriorated to various degrees due to prolonged exposure to high temperature and humidity. The second battery still offered a marginal capacity of 634 mAh and the third battery had deteriorated to 58 mAh. It has been estimated that 500 mAh is acceptable capacity for this application, which would make the marginal second battery still acceptable, but the third battery should be flagged for replacement.

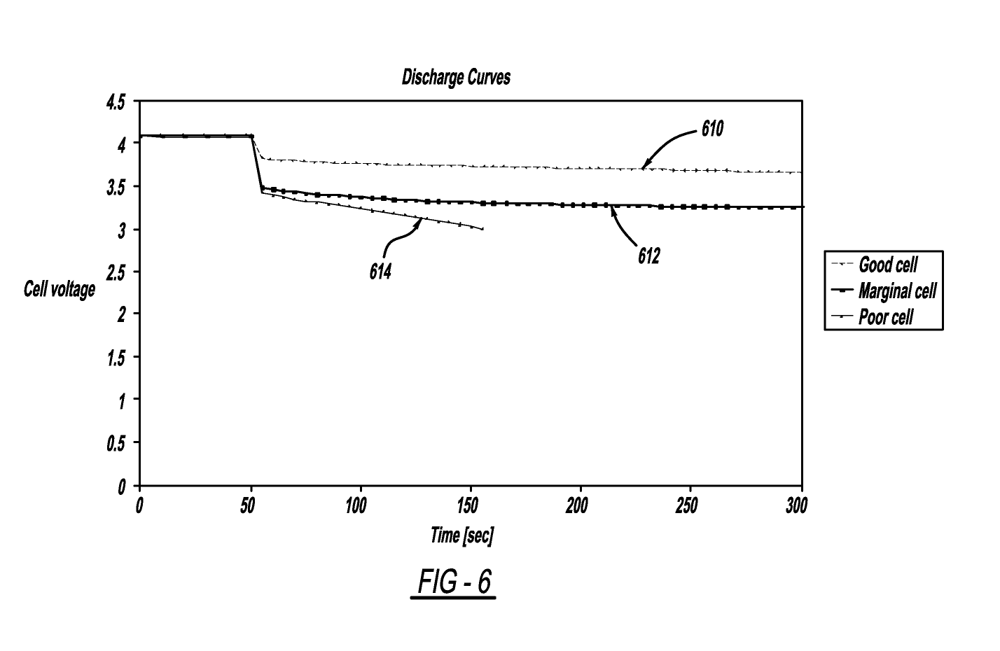

Now referring to FIG. 6, a graph is illustrated showing the first portion of a discharge curve of the three batteries in FIG. 5. The load is applied at the fifty second time point. The first battery is illustrated by line 610. The second marginal battery is illustrated by line 612, while the third battery is illustrated by line 614. A DC load quick test gave a reading of 124 mΩ for the first battery, which is in the typical range for new cells. However, the marginal second battery and the bad third battery had readings of 291 and 299 mΩ, which are undistinguishable by themselves considering the tolerance of the common measurements. However, the method described above analyzes the initial part of the discharge curve of the battery after the load is applied.

As mentioned above, the load is applied at 50 second time point. An initial drop equivalent to a DC load test can be seen immediately after the load is applied for each of the curves. The graph indicates that the initial drop is almost identical for the second marginal battery and the third bad battery. After, 100 seconds it is obvious that the third battery is almost completely discharged, while the first battery and second and marginal battery still have some capacity left. If a few data points were taken for each of the curves, the total capacity of the battery can be estimated based on the slope of the curve. Based on the slope, the system can determine if the battery should be flagged for replacement or it can still be considered usable.

The testing period of 100 seconds would deplete approximately 55 mAh of the battery, which is about 4.3% of the capacity of the first good battery and 8.8% of the capacity of the second marginal battery. At no point in time was the critical back-up functionality jeopardized, and the recharge energy and time are relatively minor.

The described method can be used for diagnostics of the Lilon backup batteries in the telematics systems, particularly stolen vehicle tracking SVT platforms. It is also ideal for any system that uses a Lilon battery as backup, keeping it in fully charged state at all times except when power back-up is needed.

In other embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

I claim:

1. A system for testing a battery, the system comprising:
a network access device;
a network access device battery configured to communicate with the network access device for providing supply power; and
a battery test circuit configured to monitor an output of the network access device battery and determine a battery status based on a slope of an initial portion of a battery discharge curve.

2. The system according to claim 1, wherein the battery test circuit includes a load connected to the network access device battery.

3. The system according to claim 1, the battery test circuit including a voltage sensor in communication with the load to determine a battery status.

4. The system according to claim 1, wherein a processor is configured to communicate with the voltage sensor to determine the battery discharge curve.

5. The system according to claim 1, wherein a switch is provided in electrical series connection between the network access device battery and the load.

6. The system according to claim 5, wherein the processor is configured to activate the switch to connect the load in electrical series with the network access device battery when the processor is determining the battery discharge curve and deactivate the switch to disconnect the load from the network access device battery when the processor is not determining the battery discharge curve.

7. The system according to claim 1, wherein the processor is configured to apply a threshold to the average slope of the initial portion of battery discharge curve.

8. The system according to claim 1, wherein the processor is configured to apply a threshold to the average acceleration of the battery discharge curve.

9. The system according to claim 1, wherein the processor is configured to determine the battery status based on a combination of two or more of an average slope of the initial portion of the battery discharge curve, an average acceleration of the battery discharge curve of the initial portion of the battery discharge curve, a maximum slope of the initial portion of the battery discharge curve, a the maximum acceleration of the initial portion of the battery discharge curve.

10. The system according to claim 1, wherein the initial portion of the battery discharge curve is the first one minute to the first five minutes of battery discharge.

11. The system according to claim 1, wherein processor is configured to periodically initiate determining the battery status.

12. A battery test circuit for testing a battery, the battery test circuit comprising:
a load in electrical series connection with the battery;
a sensor configured to communicate with the battery and measure a battery discharge curve; and
a processor configured to monitor an output of the network access device battery and determine a battery status based on a slope of an initial portion of a battery discharge curve.

13. The system according to claim 12, wherein a switch is provided in electrical series connection between the battery and the load.

14. The system according to claim 13, wherein the processor is configured to activate the switch to connect the load in electrical series with the battery when the processor is determining the battery discharge curve and deactivate the switch to disconnect the load from the battery when the processor is not determining the battery discharge curve.

15. The system according to claim 12, wherein the processor is configured to apply a threshold to the average slope of the initial portion of battery discharge curve.

16. The system according to claim 12, wherein the processor is configured to apply a threshold to the average acceleration of the battery discharge curve.

17. The system according to claim 12, wherein the processor is configured to determine the battery status based on a combination of two or more of an average slope of the initial portion of the battery discharge curve, an average acceleration of the battery discharge curve of the initial portion of the battery discharge curve, a maximum slope of the initial portion of the battery discharge curve, a the maximum acceleration of the initial portion of the battery discharge curve.

18. A method for testing a battery, the method comprising:
connecting a load in electrical series connection with the battery;
monitoring an output of the battery; and
determining a battery status based on a slope of an initial portion of a battery discharge curve.

19. The method according to claim 18, further comprising activating a switch to connect the load in electrical series with the network access device battery when the battery discharge curve is being determined and deactivating the switch to disconnect the load from the network access device battery when the battery discharge curve is not being determined.

20. The method according to claim 18, wherein the battery status is determined based on one or more of an average slope of the initial portion of the battery discharge curve, an average acceleration of the battery discharge curve of the initial portion of the battery discharge curve, a maximum slope of the initial portion of the battery discharge curve, and a maximum acceleration of the initial portion of the battery discharge curve.

21. In a computer readable storage medium having stored therein instructions executable by a programmed processor for testing a battery, the storage medium comprising instructions for:
connecting a load in electrical series connection with the battery;
monitoring an output of the battery; and
determining a battery status based on a slope of an initial portion of a battery discharge curve.
